(19) United States
(12) Patent Application Publication
(10) Pub. No.: US 2011/0016088 A1
(43) Pub. Date: Jan. 20, 2011

(54) SYSTEM AND METHOD FOR PERFORMANCE AND CAPACITY MONITORING OF A REDUCED REDUNDANCY DATA STORAGE SYSTEM

(76) Inventor: Stephen Philip SPACKMAN, San Jose, CA (US)

Correspondence Address: KRAGULJAC & KALNAY, 4700 ROCKSIDE ROAD, SUMMIT ONE, SUITE 510, INDEPENDENCE, OH, 44131, US

(21) Appl. No.: 12/506,101

(22) Filed: Jul. 20, 2009

(51) Int. Cl. G06F 17/30

(52) U.S. Cl. 707/637; 707/E17.005

(57) ABSTRACT

In accordance with certain aspects of the present invention, an anticipatory integrated system and method for performance and capacity monitoring and management of a data redundancy backup system is disclosed. In one embodiment, capacity and system performance benchmark parameters set in backup appliances prior to customer shipment are integrated into the backup appliance shipped to the customer to perform real-time field monitoring and analysis of system performance and capacity requirements. In one embodiment, these parameters are updated over time on the basis of local measurements and remotely loaded data. In one embodiment, the capacity and performance component may be usable as a standalone simulation tool to provided system modeling, monitoring and prediction of the performance and capacity requirements as the system is used by the customer.

### BACKGROUND

Conventional computer data storage systems, such as conventional file systems, organize and index pieces of stored data by name or identifier. These conventional systems make no attempt to identify and eliminate repeated pieces of data within the collection of stored files. Depending on the pattern of storage, a conventional file system might contain a thousand copies of the same megabyte of data in a thousand different files. A reduced redundancy storage system reduces the occurrence of duplicate copies of the same data by partitioning the data it stores into sub-blocks and then detecting and eliminating duplicate sub-blocks. See WILLIAMS, U.S. Pat. No. 5,990,810, incorporated herein by reference in its entirety describing other aspects of such systems.

This technique is also referred to as “de-duplication technology” in the computer storage field. The goal is to reduce the amount of capacity consumed by file storage. The ultimate storage is typically on durable storage such as magnetic tape, hard disk or flash memory, but this is of course is not limiting. Typically in such systems as files are written into the system (or alternatively in a subsequent, separate de-duplication step) they are analyzed by a de-duplication engine (processor) and broken into sub-files referred to as sub-blocks or blocklets.

Each blocklet is examined by the engine to see if it is unique. If it is, the blocklet is stored to disk and consumes disk or tape capacity. If the blocklet is determined not to be unique that means it has already been stored and one of the two copies may be discarded. After the entire file has been examined, an index record is stored that lists what blocklets or sub-blocks make up the file and how to rebuild the file, that is how to locate them in the storage.

More technically, this approach to data storage reduction systematically substitutes reference pointers in the index for redundant fixed or variable-length blocks or data segments, also referred to as blocklets or sub-blocks, in a specific data set. The more sophisticated version uses variable length data segments. Data de-duplication operates by partitioning the file into the blocklets (sub-blocks) and writing those sub-blocks to a disk or tape. To identify the sub-blocks in a stream, the data de-duplication engine creates a digital signature, also sometimes referred to as a fingerprint, for each sub-block, and an index of all the digital signatures for a given storage repository.

The index, which can be recreated from the stored sub-blocks, provides a reference list to determine whether sub-blocks already exist in the repository. The index is used to determine which new sub-blocks need to be stored or alternatively which old sub-blocks can be discarded and also which need to be copied during a reproduction operation. When the data de-duplication engine determines that a particular sub-block has been processed (stored) before, instead of storing the sub-block again it merely inserts a pointer to the original sub-block in the “metadata” kept in the index. If the same sub-block shows up multiple times, multiple pointers to it are generated.

There are two distinct kinds of access structures, an “index,” which is used to locate pre-existing copies of blocklets given their signatures (it maps identifiers to location), and used on data ingest and “recipes,” which specify the particular blocklet lists associated with files or “blobs” in terms of the blocklet identities and/or locations. The pointers refer, directly or indirectly, to the physical location or address in the magnetic tape or hard disk block storage. Variable-length sub-block de-duplication technology stores multiple sets of discrete recipe images, each of which represents a different file, but all of the sub-blocks are contained in a common storage pool and share a common index of blocklet signatures. Since use of variable-length data segments is well known, it in not further referred to here, but it is understood that it may be used in accordance with the present invention. De-duplication technology is often used to store backup data in large computer systems, but that again is not limiting.

Such a de-duplication system is most advantageous when it allows multiple sources and multiple system presentations to write data into a common de-duplicated storage pool. This has been commercially achieved by Quantum Corp., assignee of this application. Typically access is provided to a common de-duplication storage pool, also known as a “block pool”, through multiple presentations that may include any combination of (virtual) disk storage volumes or (virtual) magnetic tape libraries. Because all the presentations access the common storage pool, redundant blocklets or sub-blocks are eliminated across all data sets being written to the system.

Typically the pool of sub-blocks when stored in a data storage system is indexed by the sub-block index. By maintaining this index of the sub-blocks the storage system determines whether a new sub-block is present in the storage system and if it is, easily determines its location. The storage system then creates a reference to the existing sub-block rather than storing the same sub-blocks in the pool. Thereby considerable storage space may be saved. Each sub-block index entry provides information to identify the sub-block thereby distinguishing it from all others and information about the actual location (storage address) of the sub-block within the sub-block pool for retrieval.

Typically the index is referred to very frequently since each new BLOB received must be divided into sub-blocks and many of the sub-blocks looked up in the index. An index may be held in random access memory or on a hard disk although holding it in random access memory access is much quicker since a hard disk is relatively slow to access. Thus the index may be stored either in random access memory or equivalent, alone or in combination with other storage such as disk, tape or flash memory.

FIG. 1A is a prior art representation of a repository of subblocks 100 indexed by a subblock index 120. By maintaining an index of subblocks 120, a storage system can determine whether a new subblock is already present in the storage system and, if it is, determine its location. The storage system can then create a reference to the existing subblock 109 rather than storing the same subblock again.

Predicting the behavior and required capacity of de-duplications storage systems as depicted in FIG. 1A poses challenges not found with previous backup storage technologies. While the compaction of backup data through de-duplication has great benefits in reducing the overall storage cost of a system, it has an associated system management cost which makes its overall space consumption behavior much harder to understand.

With the current thrust in computing tilting towards higher efficiency, whether per dollar, per watt, per labor hour or per unit of physical resources, current computing environments are saddled with several problems including a reduction in excess capacity requiring systems to operate closer to the edge of their envelopes thereby increasing the brittleness of their behavior.

As data de-duplication backup devices move from the lab into the field, system capacity and performance effects that vary from the performance and capacity benchmarks set in the lab must be reconciled in the field. Consequently, a data de-duplication backup system will benefit from an improved monitoring system, to provide sharper provisioning, early warning of system capacity shortfalls, better safeguarding of margins for sporadic operational loads and better oversight of overall system performance.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In accordance with certain aspects of the present invention, an improved system and method of providing an integrated anticipatory system monitoring and managing data de-duplication backup systems is disclosed. In one embodiment, the present invention provides a system that provides sharper provisioning, early warning of system capacity shortfalls, better safeguarding of margins for sporadic operational loads and disaster recovery and a better concern for load growth in a backup appliance.

In one embodiment, capacity and system performance benchmark parameters set in appliances prior to customer shipment are integrated into the appliance shipped to the customer to perform real-time field monitoring and analysis of system performance and capacity requirements. In one embodiment, these parameters are updated over time on the basis of local measurements and remotely loaded data. In one embodiment, the capacity and performance component may be usable as a standalone simulation tool to provided system modeling, monitoring and prediction of the performance and capacity requirements as the system is used by the customer.

### DESCRIPTION OF THE DRAWINGS

The accompanying drawings, which are incorporated in and form a part of this specification, illustrate embodiments of the subject matter and, together with the description, serve to explain principles discussed below.

FIG. 1A depicts a conventional subblock repository and an index that makes it possible to locate any subblock in the repository.

FIG. 1B depicts exemplary block diagram of one embodiment of a multi-node backup system capacity monitoring and management system, according to one embodiment of the present invention.

FIG. 2 depicts exemplary block diagram of one embodiment of a backup system capacity monitoring and management system, according to one embodiment of the present invention.

FIG. 3 is a block diagram of one embodiment of a user interface module illustrated in FIG. 2, according to one embodiment.

FIG. 4 depicts a block diagram of one embodiment of the internal details of the user interface module illustrated in FIG. 3, according to one embodiment.

FIG. 5 depicts a block diagram of one embodiment of a data interface module illustrated in FIG. 3, according to one embodiment.

FIG. 6 depicts a block diagram of one embodiment of a communication interface module illustrated in FIG. 3, according to one embodiment.

### DETAILED DESCRIPTION

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the following detailed description, numerous specific details are set forth in order to provide a thorough understanding of embodiments of the subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the detailed description, discussions utilizing terms such as “partitioning,” “creating,” “compressing,” “identifying,” comparing,” “referencing,” “reassembling,” “accessing,” “viewing,” “associating,” “updating,” “adding,” “deleting,” “generating,” “determining,” “controlling,” or the like, refer to the actions and processes of a computer system, data storage system, storage system controller, microcontroller, processor, or similar electronic computing device or combination of such electronic computing devices. The computer system or similar electronic computing device manipulates and transforms data represented as physical (electronic) quantities within the computer system's/device's registers and memories into other data similarly represented as physical quantities within the computer system's/device's memories or registers or other such information storage, transmission, or display devices.

### Overview of Discussion

According to one embodiment, the apparatus for capacity and performance monitoring of the present invention models the dynamic behavior of data de-duplication backup device installations. In one embodiment, the present invention includes system management modules that provide integrated performance and capacity modeling of backup system installation to provide a more accurate up-front provisioning through a standalone tool that allows various user interface functions. These functions include allowing users to experiment with the effect of different system policies, schedules, and failure models. The invention further provides a single standalone engine which is usable in several different tools to allow functions such as an integrated modeling/monitoring functionality for providing online and historical data which alert users to system capacity and performance issues in the backup system.

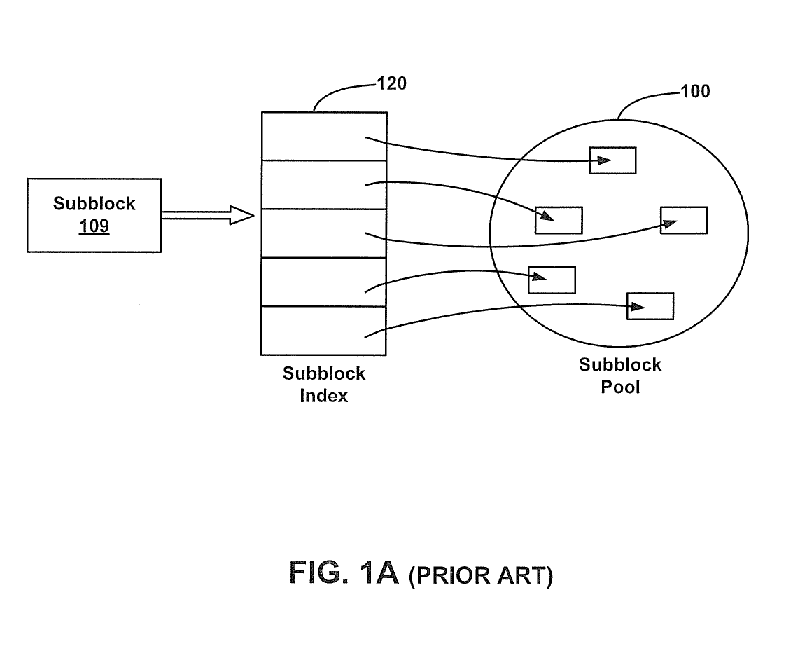

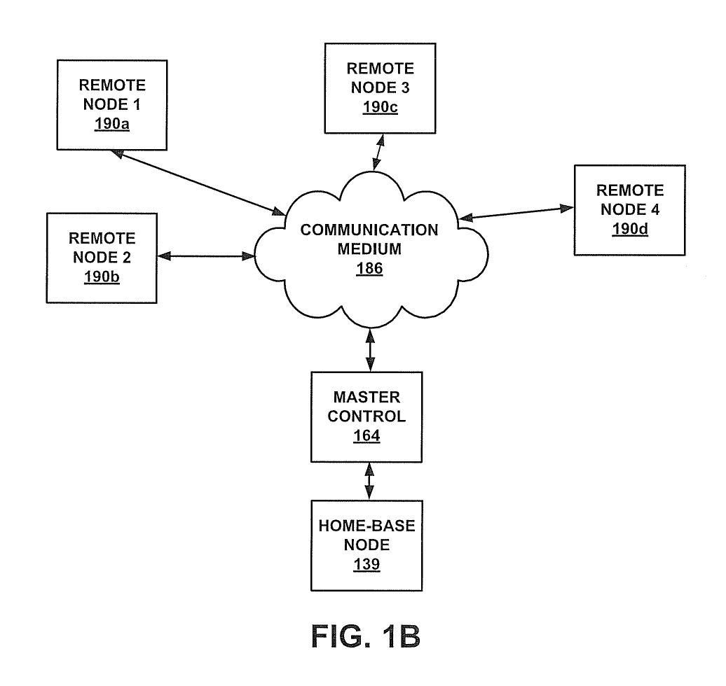

FIG. 1B depicts an exemplary block diagram of one embodiment of a multi-node backup system capacity monitoring and management system, according to one embodiment of the present invention.

It is appreciated that embodiments of the present invention can be implemented on a multi-node environment. The multi-node environment of FIG. 1B shows remote nodes 190a, 190b, 190c and 190d that each communicate with and are controlled by master controller 164. The nodes communicate with the master controller 164 via communication medium 186. In one embodiment, the master controller is associated with a home-base node 139. In one embodiment, configuration, load, policy and plan data from each of the nodes is retrieved and updated by the master controller 164.

### An apparatus and Method for Capacity and Performance Monitoring and Management in a Reduced Redundancy Data Storage System

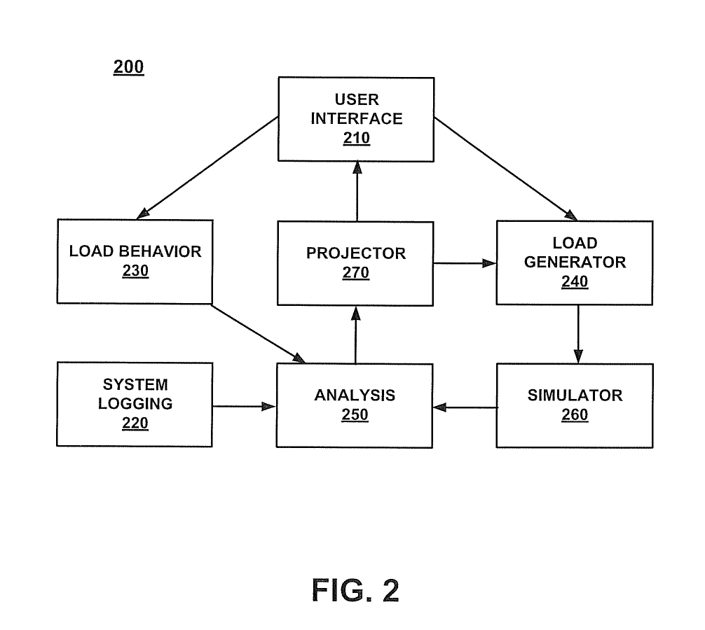

FIG. 2 is a block diagram of an apparatus 200 for performance and capacity monitoring in a reduced redundancy data storage system, according to one embodiment. The apparatus 200 may be used both as a standalone simulation tool or an integrated anticipatory system monitor for reduced redundancy storage systems. In one embodiment, the apparatus 200 provides more efficient provisioning, early warning of capacity shortfall, better safeguarding of margins for sporadic operational loads and disaster recovery and better oversight of load growth of the storage system. The blocks that represent features in the apparatus 200 in FIG. 2 can be arranged other than as illustrated, and can implement additional or fewer features than are described herein. Further, the features represented by the blocks in FIG. 2 can be combined in various ways other than depicted in the figure. The apparatus 200 may be implemented using software, hardware, firmware, or a combination thereof.

In one embodiment, the apparatus 200 comprises a user interface module 210, a data extraction and logging module 220, a load and gross behavior module 230, a simulated load generation module 240, an internal performance analysis module 250 a simulation engine module 260, and a projection module 270. In one embodiment, the user interface module 210 provides a mechanism for load characterization and system requirement elicitation. The user interface module 210 also provides system configuration, forward provisioning and projection delivery and exploration features.

The data extraction and logging module 220 provides a distinct standalone log retention and consolidation feature for monitoring events and maintaining system history in the backup system. In one embodiment, the data extraction and logging module provides a single point of access for performance and load data. The data extraction and logging module 220 relies on monitoring interfaces throughout the storage system for its inputs. The load and gross behavior analysis module 230 performs analysis of presented loads, comparison of loads with declared schedules and specified/licensed capacity of the backup system. The load and gross behavior analysis module 230 also provides a mechanism for comparing the performance of the backup system utilizing specified user requirements. In one embodiment, the load and gross behavior analysis module 230 performs the load analysis by comparing, for example, the time series of the backup system with simple bracket criteria, for example, did a particular process complete on schedule and without exceeding specified maxima. In one embodiment, it extends to statistical analysis of time series.

The simulated load generation module 240 generates synthetic loads for system analysis and projections. The simulated load generation module 240 accepts inputs from both a user-oriented planning interface in the user interface module 210 or from the projection module 270. The output of the simulated load generation module 240 is compatible with the corresponding output from the behavior analysis module 230. In one embodiment, the simulated load generation module 240 generates (simulated) events such as system component failures as well as system backup loads. The simulated load generation module 240 is also capable of generating load requests with randomized characteristics to respond to questions about disaster preparedness of the backup environment.

Still referring to FIG. 2, the internal performance analysis module 250 analyses the internal state and performance variables of a live or simulated system. The internal performance analysis module 250 provides a means for determining achievable throughputs of the various logical system components of the apparatus 200. This may include the variation of the components over time (since effect like index growth and block-pool fragmentation will cause them to change). The internal performance analysis module 250 enables identification of component inputs that are backlogged and thus yield a measurement of the maximum achievable service rate under a given circumstance from cases in which the component is input limited and providing at a lower bound. The internal performance analysis module 250 also provides a mechanism to model the interaction between components as the achievable throughput of one module must in general be seen as a function of the concurrent activities of other modules.

The simulation engine module 260 provides a parametric event-driven simulator where the parameters are derived from the system configuration and the results of the performance analysis component. In one embodiment, the events are typically not simple punctual events, but changes in presented loads and internal processing states. They are driven both externally by the start and end of I/O loads and internally by work queue state changes (e.g., between the three canonical states of empty, backlogged and input limited). In one embodiment, the simulation engine module 260 may be of a modular OO style so that complex, multimode systems are not significantly harder to construct than basic configurations. In one embodiment, the simulation engine module 260 is driven by projected data form the projection module 270 in order to get a view into the future and from historical data in order to both cross-validate the model itself and to detect anomalies in system behavior.

The projection module 270 performs analytic projection of future trends in independent variables which can be fed back into the simulator via the load generation component. In one embodiment, analysis of other independent, environmental data such as power loss events, network bandwidth availability, etc., may be used for load analysis.

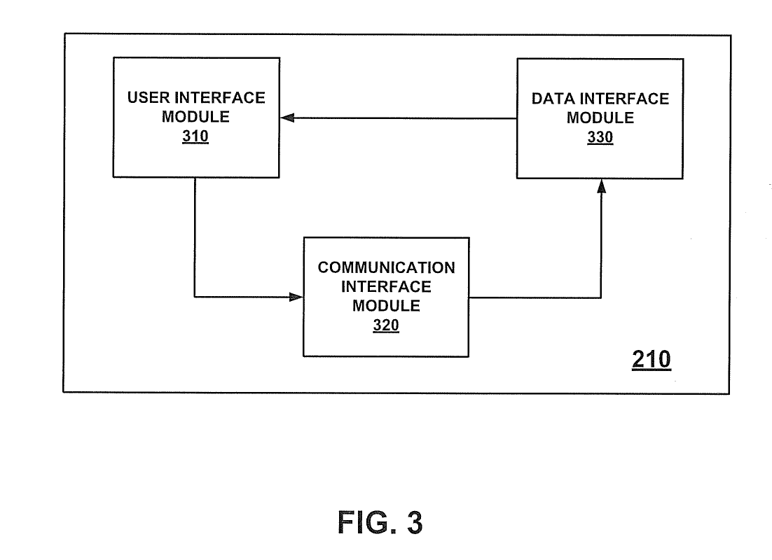

FIG. 3 is a block diagram illustrative of one embodiment of the interface module 210 according to the present invention. As shown in FIG. 3, the interface module 210 comprises user interface module 310, data interface module 320 and communication interface module 330.

In one embodiment, the user interface module 310 provides an interactive mechanism for the user to configure and monitor the performance and capacity monitoring system 300. In one embodiment, the user interface module 320 is bi-directional and enables the user to dynamically and interactively compare pre-defined system performance expectations with in-line observed behavior of the system.

In one embodiment of the invention, implementing the communication interface module 320 assumes an environment with a potentially distributed implementation in which there is more than one de-duplication storage device managed from a single location. In such an environment, the data communication interface module 320 provides a number of data interfaces which enable new components to the system to acquire information from a host of system and store persistent state of the host system.

The communication interface module 330 provides a mechanism for sharing information between remote nodes 190 of an installation and routine data exchange with the master control node 164 in a multimode installation, and delivery of notifications to the system manager at a central monitoring station and/or the home base node 139.

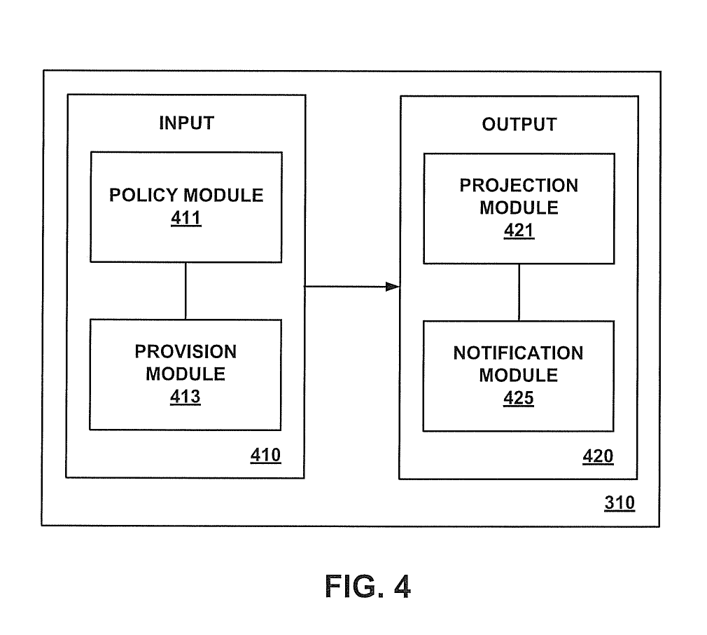

FIG. 4 depicts a block diagram illustrating one embodiment of the internal components of the user interface module 310 according to the present invention. The embodiment illustrated in FIG. 4 comprises an input module 410 and an output module 420.

In one embodiment, the input module 410 comprises a policy module 411 and a provisioning module 413. The policy module 411 is responsible for eliciting policies and requirements from the system administrator of the storage device. In one embodiment, the policy interface module 411 is designed to account for changes over time. The module 411 may be used both for speculative investigation and for planning configurations. The information elicited by the policy module 411 may include backup load characterization, restore load characterization and system robustness and performance requirements. In one embodiment, the backup load characterization information may include the physical and logical interfaces employed, the identity of the primary applications using the storage backup schedules (if the storage device is used as a backup target), payload sizes, known statistics such as compressibility, rate of data change, retention policy, etc.

The provision and planning module 413 provides a mechanism for complete description of the configuration, including connections to remote replication targets and their configurations and load characterizations. In one embodiment, the provisioning and planning module 413 provides a mechanism for constructing models of future system configurations. In one embodiment, the provisioning and planning module 413 elicits system information including hardware configuration information, operational modes, interconnection information, etc., to implement the provision and configuration planning.

In one embodiment, the provisioning and planning module 413 takes into account phased system deployment to allow for both speculative exploration and declaration of system upgrades and configuration changes.

Still referring to FIG. 4, the output module 420 comprises a projection delivery module 421 and a notification module 425. In one embodiment, the projection delivery module 420 gathers the input parameters and dynamic performance data and provides the results of the analysis of the data to the user. There are several formats that may be chosen to present the data to the user. These include go/on-go, percentage of capacity information, connection subscription, and graphical representation of system dynamics over time.

The notification module 425 delivers capacity shortfall information to the user. In one embodiment, the notification information is provided on-line as part of the routine management interface of the backup system or off-line through a external delivery system, such as email. The shortfall information provided by the notification module 425 may include system failure information, capacity information, notification of aberrant system behavior and upgrade/expansion requirement information.

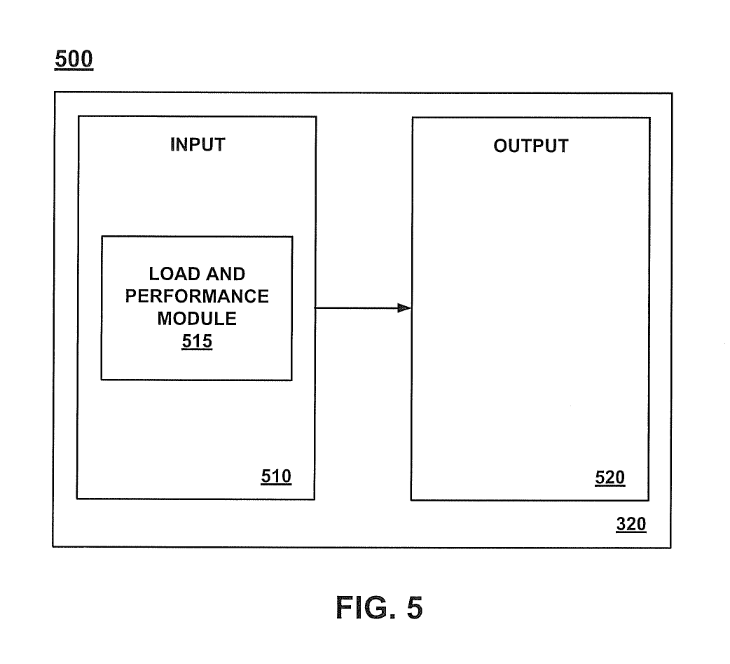

FIG. 5 is a block diagram illustration of one embodiment of the data interfacing module according to the present invention. The data interfacing unit 330 comprises input module 510 and output module 520. In one embodiment, the input module 510 comprises a configuration acquisition unit that provides information on actual static configuration of the system in both present and historical context.

The load and performance data acquisition module 515 handles data received about on-going performance of the system. The performance data received by the load and performance acquisition module 515 may include event timing, size and throughput information for ingest and retrieval, along with processing efficiency, queue lengths and service times of the system processes in the backup device.

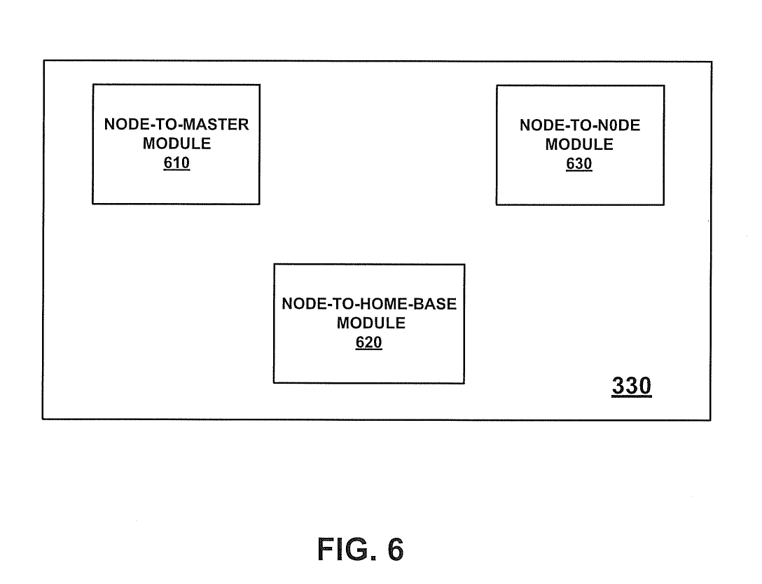

FIG. 6 is a block diagram of one embodiment of the communications interface module 330 according to the present invention. As shown in FIG. 6, the communication interface module comprises a node-to-master module 610, a node-to-node module 630, and a node-to-home-base module 620.

In one embodiment, the node-to-master module 610 provides a mechanism to enable the retrieval and updating of all configuration, load, policy and planning data from each node 164, 190 that collaborates in the protection.

In one embodiment, the information to be retrieved and manipulated includes the data input to the local model of the remote node. In one embodiment, the present invention allows acceptance of notification of dynamic updates of the system configuration.

The node-to-node communication module 630 provides a mechanism for nodes to communicate with each other on an on-going basis. In one embodiment, each node in the backup eco-system is responsible for its own on-going monitoring and communication of upstream and downstream replication loads and schedules externally visible configuration changes and plans, and feedback about operational status and planned operational statistics.

In one embodiment, the nodes provide each other with projections or data to make projections of their own anticipated behavior in the case of node or communication failures. This allows nodes suffering the loss of a peer to make meaningful predictions with respect to the recovery process once service is resumed.

The node-to-home-base communication module 620 provides a mechanism to allow the system to, in effect, place service calls on its own behalf by contacting the vendor (or in the case of a high security establishment, a proxy system for the vendor). In one embodiment, the remote nodes may transfer measured system performance figures, system health/stability measures and a notice of capacity exhaustion homeward to the home-base. In a similar manner as the notifier module provides messages relating to on-going system health and stability to be delivered to the user.

Example embodiments of the subject matter are thus described. Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A data de-duplication storage device having a capacity and performance monitoring and management system, the system comprising:
a capacity and performance modeling module for modeling pre-shipment capacity and performance benchmark parameters for the backup device on the basis of its type and configuration;
a capacity and performance monitoring module for monitoring the capacity and performance of the backup device in operation; and
a capacity and performance prediction module for predicting capacity and performance shortfalls in the backup device under various assumptions about future activity.

2. The system as recited in claim 1, wherein the capacity and performance modeling module further models iterations of different system components and multi-node installation dynamics in the backup device.

3. The system as recited in claim 2, wherein the modeling module further provides on-line active modeling of the backup device to raise alerts when the backup device encounters unsustainable capacity and performance situations prior to any operational shortfalls.

4. The system as recited in claim 3, wherein the capacity and performance monitoring module monitors availability of reserve resource capacity in the backup device during use.

5. The system as recited in claim 4, wherein the capacity and performance monitoring module further monitors use pattern accuracy to drive capacity provisioning in the storage device.

6. The system as recited in claim 1, wherein the capacity and performance monitoring module, comprises:
a user interface module;
a data extraction and logging module for monitoring events and maintaining historical data of performance and load status of the backup device;
a load and gross behavior analysis module for performing analysis of presented load with declared schedules and capacity utilization with user requirements in the backup device;
a simulated load generation module for generating loads in the backup device; and
an internal performance analysis module for analyzing the internal state and performance variables of the backup device during operation.

7. The system as recited in claim 6, wherein the capacity and performance monitoring module further comprises a parametric event-driven simulation engine for handling parameter derived from system configuration and performance analysis results.

8. The system as recited in claim 7, wherein the user interface module comprises a load characterization elicitation module for characterizing loads including write traffic and read traffic in the storage device.

9. The system as recited in claim 8, wherein the user interface module further comprises a policy requirement elicitation module for eliciting policies which enable the backup device to obtain storage performance and robustness requirements from the backup device administrator.

10. The system as recited in claim 9, wherein the user interface module further comprises a forward provisioning module for providing user level configuration parameters including system hardware configurations, operational modes and interconnects for replication and remote I/Os of the backup device.

11. The system as recited in claim 12, wherein the user interface module further comprises a projection delivery and exploration module for presenting analysis of input parameters and performance data dynamically to the user.

12. The system as recited in claim 11 wherein the user interface module further comprises a notification module to provide capacity shortfall notices including anticipated shortfall to the user.

13. The system as recited in claim 12, further comprising a configuration acquisition module for acquiring actual static configuration of the backup device to be used for monitoring the backup device to detect shortfalls as the loads in the backup device change.

14. The system as recited in claim 13, wherein the configuration acquisition module further acquires historical versions of configuration information of the backup device to enable the system to dynamically compare current system performance with past observations.

15. A data de-duplication backup system, comprising:
a data ingestion module for accepting input data from a backup source and staging the input data incrementally to a stable store;
a de-duplication module for receiving the ingested input data and segmenting the ingested data against a database of known data chunks;
a replication module for transferring stored backup images to remote secondary backup sites;
a reclamation module for expired data in the database designated for retention or recycling depending on the expiration of the data; and
an anticipatory integrated capacity and performance monitoring and management module for monitoring and managing the backup device to ensure that resources shortfalls in the backup device are identified early to predict the health and stability of the backup system in the field.

16. The data de-duplication backup system as recited in claim 15, wherein the anticipatory integrated capacity and performance monitoring and management module comprises:
a user interface module;
a data extraction and logging module for monitoring events and maintaining historical data of performance and load status of the backup device;
a load and gross behavior analysis module for performing analysis of presented load with declared schedules and capacity utilization with user requirements in the backup device;
a simulated load generation module for generating loads in the backup device; and
an internal performance analysis module for analyzing the internal state and performance variables of the backup device during operation.

17. The data de-duplication backup system as recited in claim 16, wherein the anticipatory integrated capacity and performance monitoring module further comprises parametric event-driven simulation engine for handling parameter derived from system configuration and performance analysis results.

18. The data de-duplication backup system as recited in claim 17, wherein the user interface module comprises a load characterization elicitation module for characterizing loads including backup loads and restore loads in the backup device.

19. The data de-duplication system as recited in claim 18, wherein the user interface module further comprises a policy requirement elicitation module for eliciting policies which enable the backup device to obtain storage performance and robustness requirements from the backup device administrator.

20. The data de-duplication system as recited in claim 19, wherein the user interface module further comprises a forward provisioning module for providing user level configuration parameters including system hardware configurations, operational modes and interconnects for replication and remote I/Os of the backup device.

21. The data de-duplication system as recited in claim 19, wherein the user interface module further comprises a projection delivery and exploration module for presenting analysis of input parameters and performance data dynamically to the user.

22. The data de-duplication system as recited in claim 21, wherein the user interface module further comprises a notification module to provide capacity shortfall notices to the user.

23. The system as recited in claim 22, further comprising a configuration acquisition module for acquiring actual static configuration of the backup device to be used for monitoring the backup device to detect shortfalls as the loads in the backup device change.

24. The system as recited in claim 23, wherein the configuration acquisition module further acquires historical versions of configuration information of the backup device to enable the system to dynamically compare current system performance with past observations.
